(19) United States
(12) Patent Application Publication
(10) Pub. No.: US 2025/0013443 A1
(43) Pub. Date: Jan. 9, 2025

(54) COMPILER SYSTEMS AND METHODS FOR ACCELERATED DIFFERENTIAL ALGEBRAIC EQUATIONS (DAE) SIMULATION

(71) Applicant: JuliaHub, Inc., Boston, MA (US)

(72) Inventors: Keno Fischer, Cambridge, MA (US); Elliot Saba, Seattle, WA (US); Yingbo Ma, Newton, MA (US)

(21) Appl. No.: 18/766,120

(22) Filed: Jul. 8, 2024

Related U.S. Application Data
(60) Provisional application No. 63/512,544, filed on Jul. 7, 2023.

(51) Int. Cl. G06F 8/41

(52) U.S. Cl. CPC G06F 8/43

(57) ABSTRACT

Compiler systems and methods that solve the DAE transformation problem by simulating DAEs using general-purpose compilers are disclosed herein. The compiler systems and methods extend an existing general-purpose intermediate representation (IR) with a minimal set of intrinsics to represent the model function, which allows leveraging existing compiler technology. A first compiler input is a model of a physical system from source modeling languages. A second compiler input is a first IR for each subroutine specific to the model. The model is compiled to a second IR that is universal across multiple source modeling languages. The IR maps each primitive of the source modeling language to a subroutine call specific to the source modeling language from which the primitive is derived. The first and second IRs are combined into a third IR that describes the model in terms of intrinsics of the third IR.

### CROSS-REFERENCE TO RELATED APPLICATIONS

This application claims priority to U.S. Provisional Patent Application No. 63/512,544 (Attorney Docket No. 1207/14 PROV) filed on Jul. 7, 2023, entitled, “COMPILER SYSTEMS AND METHOD FOR ACCELERATED DIFFERENTIAL ALGEBRAIC EQUATIONS (DAE) SIMULATION,” the entire contents of which are incorporated by reference herein.

### GOVERNMENT SUPPORT

This invention was made with government support under the Defense Advanced Research Projects Agency (DARPA) under Agreement No. HR00112190048. The government has certain rights in the invention.

### TECHNICAL FIELD

The field of the invention relates generally to compiler systems and methods that simulate physical systems represented as differential algebraic equations (DAEs). Specifically, the field of the invention relates to implementing accelerated DAE simulations using a general-purpose compiler, which allows for scaling of the simulations beyond what would traditionally be possible.

### BACKGROUND

The simulation of differential algebraic equations (DAEs) is perhaps the most important problem in computational engineering. The statement is deceptively simple, just find x(t) that satisfies 0=ƒ(x, x, t), but the model function ƒ hides enormous complexity, modeling everything from the smallest computer chips to batteries, power plants, or spacecraft engines.

Writing down ƒ is itself a highly non-trivial endeavor and different fields of engineering have developed their own domain specific tools and languages. Some are fairly general, such as the Modelica language, which is widely used across engineering domains. Others are more restricted. For example, in the semiconductor modeling domain, leading edge models are commonly written in the Verilog-A language at the equation level and then composed using structural representations of electric circuits represented in formats such as SPICE or Spectre netlists.

Similarly, there is an entire academic discipline of study that concerns the development of differential equation solvers, i.e. algorithms to best (i.e., most efficiently, most accurately) obtain time-series solution x(t) given a model function ƒ. Hundreds of such algorithms have been developed, and are commonly available in modern software packages.

However, much like the source semantics of modern programming languages are often unsuitable for efficient direct execution on hardware, the model functions generated by modeling frameworks are often unsuitable for direct solving using different equation solvers. In many cases, a transformation of the model function is required (the “DAE transformation problem”). This may be required to improve the numerical stability of the model function, to compute additional information required for particular solvers (such as the derivative information), or to transform the model function into a particular specialized form required by a particular solver.

Both the Modelica-style of general-purpose simulators and the SPICE-like systems of specific simulators suffer from reaching scalability limits as models grow larger and more complex. For example, SPICE-like systems do not scale well to handle small circuits and cannot take advantage of existing DAE solvers. Modelica-style general-purpose compilers do not scale well to handle large, complex models.

The DAE transformation problem is treated as a problem in compiler development. Therefore, there is a need for systems and methods of using general-purpose compliers to simulate differential algebraic equations.

### SUMMARY

Compiler systems and methods are described herein that solve the aforementioned DAE transformation problem by leveraging general-purpose compilers. In particular, techniques and systems that solve this DAE transformation problem using a general-purpose compiler are disclosed herein. This framing is non-standard in this domain, where this transformation is often thought of as the application domain of computer-algebra systems or special-purpose compilers for particular modeling languages. The compiler systems and methods described herein include (1) a recipe for representing certain operad algebras as complier intrinsics, independent of the host language or IR (e.g. SSA based IRs such as LLVM or MLIR, or languages such as Julia, Scala or Rust), (2) an application of this recipe to DAE systems, SPICE netlists, Verilog-A files and Modelica source, (3) an implementation of these algorithms in a modem extensible compiler framework, (4) an extension of the structural singularity removal transform that resolves some ease-of-use concerns, (5) a Taylor-mode, interprocedurally demand-driven, rule based AD transform, (6) a solution to bridging the gap between source model parameterizations and generated parameterizations based on parameter optics, and (7) an implementation of this scheme in the Julia programming language and complier that demonstrates that this approach allows superior scalability to complex model functions.

In one embodiment, a compiler system for implementation on a general-purpose compiler for a source modeling language, the compiler system comprising one or more hardware processors configured for receiving an intermediate representation of a program that represents a differential algebraic equations (DAE) system in the source modeling language. The one or more hardware processors are further configured for performing structural analysis at the intermediate representation level to generate a hierarchical version of a structural incidence matrix about the DAE system. The one or more hardware processors are further configured, in a first computing pipeline, for running a plurality of structural passes using the hierarchical version of the structural incidence matrix of the DAE system. The plurality of structural passes include a first structural pass that performs index reduction to generate a set of equations to differentiate. The plurality of structural passes further include a second structural pass that performs state selection to generate an assignment of variables for the set of equations to differentiate, with each variable being represented as assigned to a particular equation, unassigned, or a selected state. The generated set of equations to differentiate and the generated assignment of variables together form a result of the structural passes. The one or more hardware processors are further configured for, in a second computing pipeline, transforming the intermediate representation based on the result of the structural passes. Transforming the intermediate representation includes performing automatic differentiation on the intermediate representation, and rescheduling the statements of the intermediate representation. The first computing pipeline and the second computing pipeline are run in parallel. The one or more hardware processors are further configured to transform each of a plurality of copies of the intermediate representation to be used with a numerical solver, compile each of the plurality of copies into an executable or other data structure for input to a numerical solver, and provide each of the executables or other data structures to the numerical solver.

### BRIEF DESCRIPTION OF THE DRAWINGS

FIG. 1 depicts a flow diagram of transformation within a traditional SPICE-like simulator.

FIG. 2 depicts a flow diagram of transformation within a traditional Modelica-like simulator.

FIG. 3A depicts a flow diagram of a method of differential algebraic equations simulations according to one embodiment of the present invention.

FIG. 3B depicts a structural incidence matrix.

FIG. 3C depicts a 2×2 subsystem.

FIG. 3D depicts the incidence matrix of the 2×2 subsystem of FIG. 3C.

FIG. 3E depicts an incidence matrix of a subsystem.

FIG. 3F depicts a pivot of the incidence matrix of the subsystem of FIG. 3E.

FIG. 3G depicts the incidence matrix of FIG. 3F after the Bareiss algorithm.

FIG. 3H depicts a possible maximal matching of the incidence matrix of FIG. 3G after the Pantiledes algorithm.

FIG. 3I depicts an incidence matrix using a pure operadic approach to taint analysis.

FIG. 3J depicts an incidence matrix of a model component function in taint analysis.

FIG. 4 depicts an exemplary process flow of a compiler system for differential algebraic equations simulations according to one embodiment of the present invention.

FIG. 5 depicts a block diagram illustrating one embodiment of a computing device that implements the methods and systems described herein.

### DETAILED DESCRIPTION

This summary is provided to introduce a selection of concepts in a simplified form that are further described below in the detailed description. This summary is not intended to identify key features or essential features of the claimed subject matter, nor is it intended to be used to limit the scope of the claimed subject matter.

The compiler systems and methods discussed herein extend an existing general-purpose intermediate representation (or programming language) with a minimal set of intrinsics in order to be able to represent the model function of a DAE system. This kind of extension is a popular technique to leverage the massive investment in compiler technology for new purposes. More recent compiler frameworks explicitly support this manner of extension. For example, MLIR features user-extensible dialects that can add custom intrinsics (operations in MLIR terminology). Similarly, the Julia compiler has been gaining significant functionality to support custom user-defined intrinsics. Some other programming languages also feature comparable compiler-extensibility mechanisms: LMS in Scala, custom DSL support in Racket, and forthcoming extensions to Rust to enable more extensive compile-time reflection.

Despite these possibilities and the relatively modest number of intrinsics, the compiler systems and methods disclosed herein have non-trivial requirements on the host environment, including the interfaces for custom analysis passes, the availability of high-performance automatic differentiation passes and the ability to handle massive amounts of IR efficiently. The implementation targets Julia, as it meets all of the targeted requirements and Julia code is used as the running example throughout the rest of this disclosure. However, the systems and methods discussed herein are not Julia-specific and may be implemented in many of the other compiler systems mentioned above, when adhering to the principles described herein.

At the basic level, there are three intrinsics: variable, ddt, and equation. The variable intrinsic introduces a new variable. Semantically, variable simply returns a Float64 (or other state type—though Float 64 is the most common and will be used as the running example), representing the value of a particular variable at the current time step (for differential variables) or the current guess of the non-linear solver (for algebraic variables). The ddt intrinsic exposes the host environment's automatic differentiation (AD) capabilities and represents the total derivative of its argument with respect to time. The equation intrinsic introduces an equation and returns an opaque reference to the equation that can be called to additively add terms to the equation as a side effect.

This disclosure describes a particular choice of intrinsics that can be thought of as an intrinsic-embedding of certain operad algebras. These operad algebras are semantic-independent representations of compositional hierarchy. Choosing intrinsics in this manner allows preserving hierarchical structure present in a source modeling language. This disclosure describes a compiler that transforms a source modeling language, whether it be SPICE, Verilog-A, VHDL-AMS, or Modelica (although Modelica requires additional handling that is discussed below) into semantically equivalent Julia program (or other intermediate representation) that, through a set of source-language-specific subroutines, ultimately makes use of these intrinsics.

From there, a general-purpose compiler, such as the Julia compiler, is used, augmented with the custom analysis and transformation that passes in three phases: (1) a generic optimization pass that treats the intrinsics opaquely and disallows inlining of any function that has a derivative rule, but is otherwise equivalent to the standard Julia pipeline. This allows the use of a significant subset of the full Julia language as the intermediate representation that serves as the compilation target for the source modeling languages, easing the implementation burden of both the translation and the language-specific subroutines; (2) specific analysis and transformation passes that analyze the structure of the DAE system and perform structural optimization similar to what a Modelica compiler might do. A generic Julia automatic differentiation (AD) pass is used to fulfill the AD requirements of the index-reduction transform. Several products are obtained, including the model function as well as a function to evaluate the Jacobian (with a similar, but slightly different AD pass). In these products, the intrinsics have been removed. (3) Splitting the resulting intermediate representation into multiple independent compilation products, each of which may undergo further transformation before ultimately becoming the inputs to a general-purpose numerical solver. The transformation products include the residual equations, jacobians, time derivatives, mass matrices, continuous and discrete callbacks, and any other input that may be required by a particular solver.

For each of the compilation products, after any required additional processing (such as another round of automatic differentiation for jacobians and time derivatives), the generic Julia optimization passes (without restrictions) are re-run and the IR is handed off to the rest of the native code generation pipeline.

The index of a DAE is an integer measure for classifying DAEs by the DAEs' degree of departure from an explicit ODE. There are various notions of index that agree on simple problems, but may differ in the general case. As a general rule, the higher the index of the DAE, the more difficult it is to solve numerically. Commonly available solvers are able to solve index-{0,1,2} DAEs numerically, but an index reduction transformation is required to solve DAEs of higher index. The differentiation index is probably the most common definition of DAE index and is usually what is meant by the index.

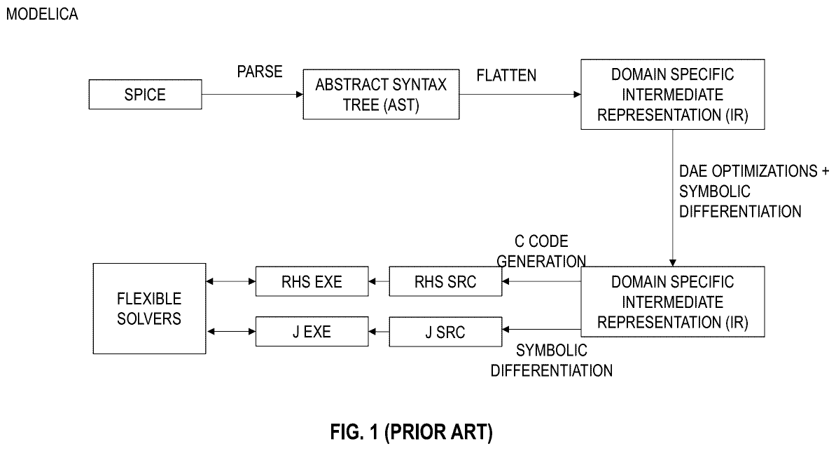

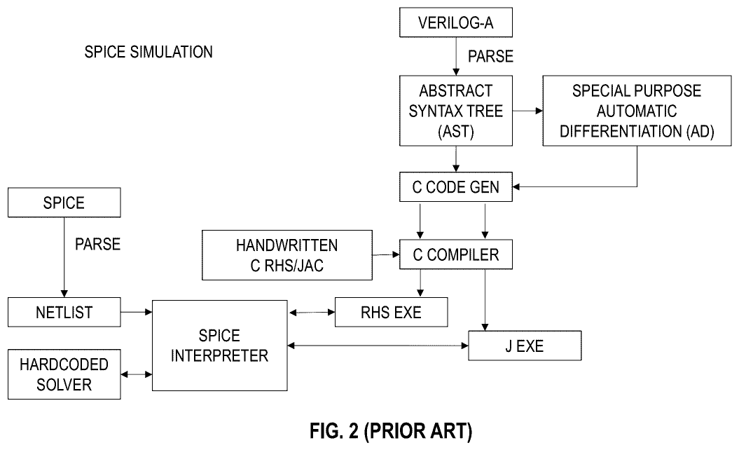

Simulators for DAEs have a rich history in many domains, with available tools, both for general-purpose simulators (e.g. Modelica-like tools) and for specific domains (e.g., SPICE-like systems). FIGS. 1-2 illustrate general mechanisms of operation for existing tools for general-purpose simulators (e.g., Modelica-like tools) (FIG. 1) and for specific domains (e.g., SPICE-like systems) (FIG. 2) and. The illustrations of FIGS. 1 and 2 describe the general mechanism of operation, rather than the specifics of any one particular tool, since several specific variations of these types of tools exist. The illustrations of FIGS. 1 and 2 are based on publicly available information; however, in both domains, proprietary tools exist and are the dominant solutions. It is possible that these solutions depart significantly from the architecture shown in FIGS. 1 and 2.

FIG. 1 depicts a flow chart for Modelica-like tools. The function of a traditional Modelica compiler can generally be described as follows. The Modelica source language is parsed into an appropriate abstract syntax tree (AST) representation. The AST representation is lowered by expanding connections and removing hierarchy to obtain an intermediate representation of the flattened system. Structural transformations, such as index reduction and tearing, are performed. Where required, derivatives are taken symbolically. C code is generated both for the model function itself, and for the Jacobian, again taking derivatives symbolically.

These kinds of systems have powerful symbolic manipulation capabilities, but they can run into scalability limits for four primary reasons. First, by discarding hierarchy (or, equivalently, array expressions) early to obtain a flattened system, there is significant re-computation of results for every instance of the model. Second, because of the equation-level symbolic representation of the model, it can be difficult to scale these systems to models that are large on a per-equation basis. For example, common transistor models used in SPICE, are thousands of lines (e.g., ˜15,000 lines of C code or ˜4,000 lines of Verilog-A for BSIM4), for a small handful of equations. Modelica compilers generally expect many equations of moderate complexity. Third, the algorithmic implementation quality of the compiler is often lower than that of state-of-the-art compilers for general-purpose languages. Fourth, the C code generation step can be a significant bottleneck.

There are ongoing efforts in the Modelica area to address some of these shortcomings. For example, the MARCO system, described in recent work by Agosta et al. describes progress towards an implementation of the Modelica language using LLVM and MLIR. However, while the possibility of preserving hierarchy is discussed, it appears that current versions of this project still rely on the OpenModelica front-end to produce a flattened representation of the original Modelica source code.

Nevertheless, this work shares some philosophical similarity with the implementation disclosed herein. For example, the method disclosed by Agosta performs automatic differentiation on MLIR's SSA representation with a custom dialect. An equivalent step exists in method disclosed herein and if instantiated in MLIR would likely look similar. Nevertheless, there are also substantial philosophical differences. The core goal of the method disclosed herein is to lower to a language-agnostic representation as quickly as possible and to re-use existing compiler infrastructure to the greatest extent possible, whereas the MARCO system relies on substantial language-specific analysis.

Others have investigated the possibility of compiling OpenModelica to Julia's ModelingToolkit.jl, which is one of the possible input formats for the compiler systems and methods disclosed herein.

FIG. 2 depicts a flow chart for SPICE-like systems. Another source of comparison is existing SPICE simulators. SPICE systems make essentially the opposite trade-off from Modelica compilers. In SPICE systems, individual device models are compiled to standalone executable units (many, but not all, existing SPICE simulators support loading additional models as shared libraries) that evaluate the right-hand side (RHS) function and the Jacobian. These models are then stitched together by “interpreting” an in-memory data-structure representing the connection graph at evaluation time. No cross-model, equation-level optimization is performed at all (although commercial implementations can perform some degree of topological optimization on the in-memory data structure). Additionally, significant aspects of the data structure selection and solver are generally hardcoded at model compilation time, limiting the available choices of solvers and the ability for the system to make dynamic performance tradeoffs based on characteristics of the input circuits.

As a result, existing SPICE simulators do not have the same scalability challenges that Modelica compilers do. However, SPICE simulators are also not capable of simulating higher-index DAEs (which requires symbolic transformation) and miss out on performance and accuracy benefits.

Originally, SPICE models were hand-coded in C (SPICE3) or Fortran (before that), evaluating both the RHS and derivatives directly and with substantial reference to solver internals, thereby making it hard, if not impossible, to switch out the solver algorithm.

Over the past 20 years, higher-level model representations, such as Verilog-A and VHDL-AMS, have risen in popularity. The compilation flow for these input representations looks somewhat similar to that of the Modelica compilers mentioned above (albeit without any equation-level optimization). In particular, language-specific AD passes are used for the implementation of both the language-level AD semantics of Verilog-A as well as the generation of the Jacobian.

In more recent work, the OpenVAF project is attempting to apply more modem compiler technology to the same problem, by lowering to LLVM (similar to the MARCO system described above). OpenVAF uses a bespoke SSA-based intermediate representation and again uses a custom AD implementation specifically for the AD needs of the Verilog-A front-end.

The transformations described herein involve a number of different representations of the same underlying semantics. The different representations may include a graphical representation (e.g., a circuit diagram, or graphical Modelica model), a textual representation (e.g., a SPICE netlist, Verilog-A model, or a textual Modelica model), various flavors of model function that implements the semantics (and is compiled from one of the higher-level representations).

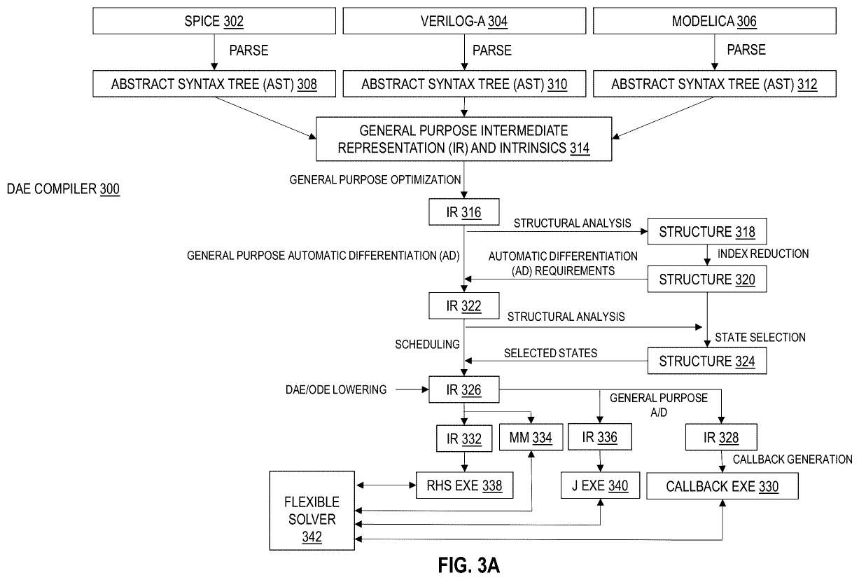

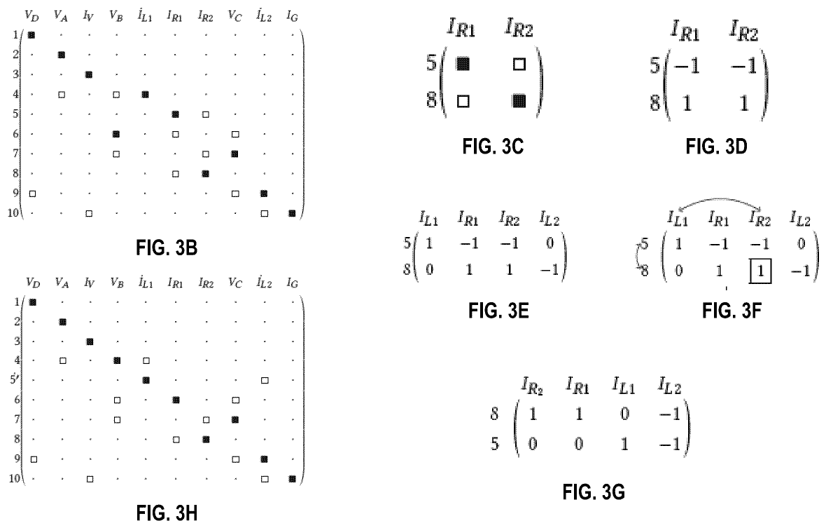

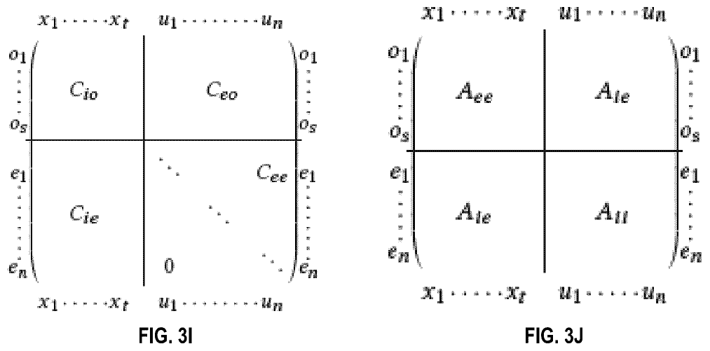

FIG. 3A depicts a block diagram showing the operation of a DAE Compiler in accordance with the compiler systems and methods described herein.

In order to discuss a model as it traverses the different stages of representation, it is helpful to have terminology that is independent of the particular representation but applies to its structure more generally. Here, the language of operads is adopted. However, neither any particular level of mathematical precision is claimed nor is the formalism of operads for formal verification used. Instead, the formalism is employed as a guide, allowing the identification of common structures in various representations.

Consider some of the important operads for the problem addressed herein. The description provided below shows structural parallels between the different representations and establishes common terminology without going for any particular mathematical precision.

### Operad Algebra of Electric Circuits

For each t, let Circ(t) denote the set of circuits with t ports. For example, batteries, capacitors, voltage sources, and all other two-terminal devices are elements of Circ(2), but so are more complicated two-port circuits, e.g., both the parallel and series compositions of a resistor and a capacitor. Similarly, bipolar junction transistors (BJTs) are elements of Circ(3), and MOSFETs are elements of Circ(4). In this formulation, the ports are numbered, so a voltage source and its port-reversed version are two different elements of Circ(2). PNP are treated as three-terminal devices and MOSFETs are treated as four-terminal devices. This is a common treatment in the application domain, where the bulk terminal of the MOSFET is treated explicitly, but the substrate terminal of a BJT is not.

UW D, which is the operad of undirected wiring diagrams is considered. Further, an Operad Algebra Circ: UW D→Set that, for any given UWD ϕ gives the function that composes circuits in accordance with the UWD is defined.

The Operad Algebra of SPICE Netlists. Modeling SPICE in this framework is complicated, for three reasons. First, SPICE is not a particularly well-defined language. Second, SPICE contains a number of concepts that are irrelevant to a goal of the present invention (e.g., parameterizations, scope resolution rules, instance/model splits, various device types). Third, SPICE has both structural (how to connect things) and semantic content, where the compiler systems and methods described herein are primarily concerned with structure.

A SPICE-like netlist notation that looks as shown below in Snippet 1 is considered.

Snippet 1

| | |
|---|---|
| 1 | .subckt phi a b c d |
| 2 | X1 a Symbol1 |
| 3 | X2 b c d Symbol2 |
| 4 | X3 c d Symbol3 |
| 5 | .ends |

A full specification of this notation is not provided. For purposes of this disclosure, the following are assumed. Open and closed circuits are not distinguished. Closed circuits are simply subcircuits without input arguments. There is only one device type ‘X’, which is taken to either be another subcircuit or a primitive model. The mechanism for symbol resolution is left unspecified. Device names are not given semantic meaning, but are merely used for identification purposes.

With these contortions, this is thought of again as an operad algebra, whose types are again FinSet. Here, operadic substitution is simply the text substitution of the corresponding line in the subcircuit with the text of the substitutee (up to non-semantic renames of symbols to avoid conflicts).

This is once again an algebra of the operad of undirected wiring diagrams, but it is worth thinking about this explicitly as a separate example. The operad of untyped, void Julia functions with side effects are considered as shown below in Snippet 2, with functions of the form:

Snippet 2

| | |
|---|---|
| 1 | function foo(a, b, c, d) |
| 2 | f1(a) |
| 3 | f2(b, c, d) |
| 4 | f3(c, d) |
| 5 | return nothing |
| 6 | end |

The symbol resolution of the functions ƒ1, ƒ2, ƒ3 is left unspecified. This is also a well-defined operad, but it is not equivalent to the operad of undirected wiring diagrams, because there are no return values by which to invent additional variables. In particular, in this model, there is only the trivial closed operad.

Snippet 3

| | |
|---|---|
| 1 | function closed( ) |
| 2 | return nothing |
| 3 | end |

The Operad of Julia functions with Array Arguments. This one is equivalent to previous one, but with a different embedding:

Snippet 4

| | |
|---|---|
| 1 | function foo(u::Vector{Float64}) |
| 2 | f1(u[1:1]) |
| 3 | f2(u[2:4]) |
| 4 | f3(u[3:4]) |
| 5 | return nothing |
| 6 | end |

The Operad of DAE Model Functions. Let Mod(t): R^{2N}→R^{2S} be the set of model component functions:

$$f ( [ \begin{matrix}\dot{x} ( t ) \\ \dot{u} ( t )\end{matrix} ] , [ \begin{matrix}x ( t ) \\ u ( t )\end{matrix} ] )$$

In the ordinary DAE definition, t is explicitly called out as a separate parameter, but here such systems are considered as being in Mod(1). Again a Cospan-algebra that acts by equating variables is obtained.

The Operad of DAE Model Functions with Explicit Equations. The methods described in this disclosure represent a slight modification of the operad of DAE model functions, in which each of the equations are considered a separate constituent type of the operad. This eases the integration into a general-purpose compiler as described below.

### Intrinsics for Differential Equations

It is addressed how to model these DAE functions inside a programming language or compiler framework. One solution here is to consider endofunctorial transformations of functions of the form f(\dot{x}, x, t). That is the form ultimately being targeted, and it is, in general, possible to generate a function of this form directly from the modeling language. This approach is feasible in general, but it has practical drawbacks as a transformation target for a modeling language. In particular, such functions are not Cospan-algebras, so if component-based, hierarchical modeling frameworks, which is true for the majority of modeling frameworks of interest, are being relied upon, there cannot be a faithful (i.e., injective) functor from the model representation to the programmatic representation.

This is an important point, so it is explored more concretely here. Model component functions have both external and internal states. There are many model functions that are mathematically equivalent, but do not have the same number of states. As a trivial example, consider the two systems:

$$0 = f ( [ \begin{matrix}\dot{x} ( t ) \\ \dot{u} ( t )\end{matrix} ] , [ \begin{matrix}x ( t ) \\ u ( t )\end{matrix} ] )$$

and

$$0 = [ \begin{matrix}f ( [ \begin{matrix}\dot{x} ( t ) \\ \dot{u} ( t )\end{matrix} ] , [ \begin{matrix}x ( t ) \\ u ( t )\end{matrix} ] ) \\ w ( t )\end{matrix} ]$$

In the above examples, where internal states w(t) have been added, the solution is simply that they are always equal to 0. Preferably, an optimizing compiler is able to replace the second system with the first. There are further complications if the internal states w are considered part of the solution object, in which the optimizing compiler would need the capability to remember that the w are always 0 in order to be able to reconstitute a full solution on request. However, if the total number of internal states is part of the semantic representation, this kind of substitution is not possible because states may not be invented out of thin air (or equations removed).

The Operad of Julia Functions with Spiders. Consider the operad previously defined, but now a single new intrinsic function spider is defined that takes no arguments, but does return a value:

Snippet 5

| | |
|---|---|
| 1 | function foo(a, b, c, d) |
| 2 | e = spider( ) |
| 3 | f1(a) |
| 4 | f2(b, e, e) |
| 5 | f3(c, d) |
| 6 | return nothing |
| 7 | end |

This operad is significantly richer and indeed is equivalent to Cospan. Therefore, there is a generic strategy for representing any UWD in program form.

Embedding Model Component Functions. This strategy can be applied to the embedding of model components, specifically the variant with implicit equations 4. First, a name for the spider must be selected. In this case, the ports of the operad are variables, so the intrinsic can be referred to as variable.

Snippet 6

| | |
|---|---|
| 1 | function bar( ) |
| 2 | a = variable( ) |
| 3 | b = variable( ) |
| 4 | c = variable( ) |
| 5 | d = variable( ) |
| 6 | foo(a, b, c, d) |
| 7 | return nothing |
| 8 | end |

However, while this completes the specification of the operad, the operad algebra has yet to be completed. To this end, the set of Julia functions generated by pure functions on the reals is considered, adjoint with a new intrinsic called equation!, which will represent the “0=” part of the model specification. Additionally, there needs to be some mechanism by which to obtain the derivatives. One way to accomplish this is to replace the spider function variable_and_derivative (treating the port types as of primal and derivative). In this way, an isomorphism of Cospan-algebras is obtained between the algebra as described previously and the representation as Julia code. All together, a full example may look like:

Snippet 7

| | |
|---|---|
| 1 | function lorenz1( ) |
| 2 | x, x = variable_and_derivative( ) |
| 3 | y, y = variable_and_derivative( ) |
| 4 | z, z = variable_and_derivative( ) |
| 5 | equation!(x − 10.0 * u) |
| 6 | equation!(y − (x * (28.0 − z) − y)) |
| 7 | equation!(z − (x * y − 8/3 * z)) |
| 8 | end |

The actual implementation uses the variant with explicit equations instead, but the basic strategy is the same, and the discussion herein is slightly simpler in this model, so it is used for the remainder of this discussion.

### General Process for Solving DAEs

While the details of the solution process vary significantly depending on the solver, it is instructive to keep a simple picture in mind for how the solver works. At every time step, the current values of the differential states are taken as input, and then a non-linear problem is solved for the derivatives of these states. The solver then performs time-integration and moves to the next time step with a new set of values for the differential states and the process repeats. In addition, most solvers will also require the Jacobian matrix of this computation.

### DAE Transform Generally

Before looking at the implementation of the compiler pass, first, the desired transform is considered. There are three rough steps of this transform. First, structural singularity removal. Second, structural index reduction. Third, partial state selection. Of these three, the latter two are essential, while the first is an enhancement that prevents failure of the latter algorithms in certain corner cases.

### Structural Index Reduction

As previously described, at every time step, a non-linear system of the top differentiated variables should be solved. However, in general, there is no guarantee that there will be a sufficient number of equations to solve this system. In particular, while it is an error for the number of states to differ from the number of equations, there is no guarantee that each of these equations involve a top-differentiated variable. However, under mild assumptions on the function, it is guaranteed that if the function is kept differentiating, eventually the extended system for the original top-differentiated variables (this is the definition of the differentiation index) is able to be (uniquely) solved.

In general, every equation does not need to be differentiated, but only a subset. The Pantelides algorithm is a structural algorithm to determine which equations to differentiate. As a structural algorithm, it is possible for the Pantelides algorithm to give a bad result (in the sense that the resulting system will not in-fact be solvable for the top-differentiated variables, thus causing attempts at numerically solving the system). An example of such a failure (and how to resolve the particular case) is provided below.

### State Selection

During state selection, a subset of the variables of the original differential equation system (or a transformed version thereof in certain advanced variants) are given as states to the numerical solver. Both the original differential equation system and the transformed system are functions of the form ƒ(\dot{u}, u, t). However, in order to distinguish the u of the original system from the u of the transformed system, the former is generally referred to as variables and the latter is generally referred to as states. The differential states (those for which the derivative appears in the function f) may be further distinguished from algebraic states (those for which it does not, i.e., the state itself is top-differentiated with respect to the particular function).

Partial State Selection. Given a (potentially structurally reduced) system of DAE equations, the Partial State Selection problem is to give a mapping assgn(v): Vars→Eqs∪{u,∫} designating each variable as either assigned to one of the equations, unassigned (represented by u), or a selected (i.e. integrated) state (represented by ∫), subject to the following constraints:
(1) A variable may only be assigned to an equation that can be solved for the assigned variable (depending on the algebraic power of the system being used to solve equations).
(2) The directed graph formed by drawing a directed edge from each variable to all other variables referenced by the assigned equation must be acyclic.
(3) The number of selected states, plus the number of constrained variables (i.e., variables that occur somewhere in the system) must match the number of non-trivial equations.

An assignment that satisfies these constraints is called a set of selected states. The assignment is not technically a set; rather the terminology refers to which states are “selected” in the sense that they are assigned to ∫ (or, in some definitions, the set of variables assigned to either ∫ or u, as these form the full set of states of the transformed system.

Dynamic State Selection. The Dynamic State Selection problem is the problem of choosing dynamically (i.e., during the numerical solution process, at various time steps) a set of selected states (as defined above) that makes the Jacobian matrix non-singular. If the algorithm decides to switch the set of selected states at a particular time point, this is referred to as a state pivot. A state pivot is not required to preserve the total number of states of the system (though it is required to preserve the number of differential states).

The different sets of selected states may be considered as analogous to coordinate charts on the tangent bundle of the solution manifold of the differential algebraic equation system (however, the dimensions of the sets of selected states need not match the dimension of the solution manifold, so these are not proper charts).

The question thus arises of how the compiler systems and methods described herein choose the set of selected states. The conditions described above are sufficient to allow transformation to a form suitable to passing to a numerical solver. However, these conditions do not guarantee that the solver will be able to solve the system (i.e., that the Jacobian of the function will be non-singular, etc.). There exist algorithms for partial state selection that will prevent from choosing sets of selected states that are unconditionally singular. In general, these algorithms involve a number of arbitrary choices that nevertheless dramatically affect the stability and efficiency of the numerical solution. In general, dynamic state selection is required to dynamically switch between these possible sets of selected states at transition points.

The Dummy Derivatives Algorithm. The Dummy Derivatives (DD) algorithm of Mattsson & Söderlind is an algorithm for choosing which states to select (i.e., which variables to assign to ∫). DD begins at the point where Index Reduction leaves off—a differentiated system for which there exists a maximal matching of the top-differentiated variables. As described above, it is assumed that there is a single strongly connected component (SCC) of top-differentiated variables.

Let V₀ denote the set of variables in this SCC, E₀ the set of equations, and form Vi and Ei by recursively taking the lower-differentiated variables and equations from the previous set. For every level i>0, take the Jacobian of variables and equations in Vi, Ei, find a non-singular submatrix, and then assign ∫ to all variables whose columns are not part of the sub-matrix.

In the original DD description, the levels are taken in highest-to-lowest differentiated order, while requiring that once a variable has been chosen as a state, so are all its lower derivatives. Equivalently, iterating in the opposite order fixes as part of the non-singular-submatrix all columns whose anti-derivatives were previously chosen as part of the nonsingular submatrix (note that the coefficient Cₖₗ at level i will always be the same as the coefficient C_{d(k)d(l)} at level i−1).

Picking a non-singular submatrix has been referred to at a particular level. However, it was previously required that the algorithm be structural. To obtain the structural variant of this algorithm, “jacobia” is replaced by “structural incidence matrix” and “non-singular submatrix” is replaced by “maximal matching.”

Tearing. Consider the partial-state-selection problem in the degenerate case where there is no differentiated states (i.e., the DAE is simply a non-linear system). In this setting, the assignment problem of variables to equations (there are no selected states, the system is non-differential) is traditionally known as “Tearing.” Many algorithms are known for this problem. In particular, the problem of tearing with a minimum number of unassigned variables is equivalent to the minimum feedback arc set problem. Any such algorithm may be used. The greedy algorithm of Otter and Elmqvist is a reasonable choice that trades off performance and optimality, though requires some additional heuristics to produce good results in practical settings.

Tearing-enhanced state selection. As described herein, tearing may be utilized to enhance the stability of state selection. To do this, the original DD algorithm is followed, except in lowest-to-highest order. Then, at every level, tearing is applied. In particular, if a state is uniquely solved for by using one of the equations disclosed herein, it is no longer a differential state. Then, the ordinary DD procedure is applied on the remaining (i.e., torn variables).

### Structural Singularity Removal

Consider a (grounded) electrical circuit consisting of a voltage source, an inductor, two parallel resistors, and another inductor. This is the grounded variant of Otter & Elmqvist's canonical example of a system with a structural singularity. After some simplification, the following ten equations are generated for this circuit by a generic modeling tool:

Equation(1):0 = V_{D} (Constituent equation for GND)
Equation(2):0 = V_{A} − 1 (Constituent equation for V)
Equation(3):0 = Iᵥ − I_{L1} (KCL at A)
Equation(4):0 =(V_{A} − V_{B}) − L₁İ_{L1} (Constituent equation for L1)
Equation(5):0 = I_{L1} − I_{R1} − I_{R2}(KCL at B)
Equation(6):0 = I_{R1} − (V_{B} − V_{C}) * R₁ (Constituent equation for R1)
Equation(7):0 = I_{R2} − (V_{B} − V_{C}) * R₂ (Constituent equation for R2)
Equation(8):0 = I_{R1} + I_{R2} − I_{L}2 (KCL at C)
Equation(9):0 =(V_{C} − V_{D}) − L₂İ_{L2} (Constituent equation for L2)
Equation(10):0 = I_{L2} + I_{G} + I_{V} (KCL at D)

Applying the Pantelides algorithm, first, the highest-differentiated variables (all but I_{L1}, I_{L2}, are in the system) should be identified. For example, the structural incidence matrix as shown in FIG. 3B may be determined. In FIG. 3B, white squares indicate structural incidence, and black squares indicate a possible maximal matching.

Now, there is a system with 10 equations and 10 variables with full structural rank. As a result, the Pantelides algorithm does nothing. However, something goes wrong at the DD stage.

FIG. 3C shows a 2×2 subsystem. FIG. 3D shows the incidence matrix of the 2×2 subsystem shown in FIG. 3C.

An issue here is that system had full structural rank but a numerical singularity, or in other words, the actual (differentiation) index exceeds the apparent structural index of the matrix.

The Solution of Otter & Elmqvist. In Otter & Elmqvist, it was proposed to preprocess the integer-linear subsystem of the original system by rewriting it to structurally expose any rank-deficiencies among the integer-linear relations of the highest differentiated variables. This is accomplished by reducing the integer-linear coefficient matrix to echelon form, picking pivots from the highest differentiated variables first.

For the sake of brevity, only the incidence matrix of the relevant subsystem is considered here, as shown in FIG. 3E; however, the full integer-linear system should be considered.

As shown in FIG. 3E, variables I_{R1} and I_{R2} are considered highest differentiated, so have pivot priority. If it is chosen to pivot on the I_{R2}/8 entry, then the first two rows and first and third columns are swapped, as shown in FIG. 3F. Then, following the Bareiss algorithm and adding it to the subsequent column, the matrix shown in FIG. 3G is obtained.

At this point the only remaining highest-differentiated variable I_{R1}, but this variable cannot be a pivot, because its coefficient is zero. Thus, it is discovered that the incidence matrix of highest-differentiated variables is rank-deficient. However, applying this linear transformation back to the original system of equations obtains:

$$0 = {I}_{L 1} - {I}_{L 2}$$

This equation replaces the original Equation (5). Equation (8) is unchanged. Equation (5)′ no longer contains any highest-differentiated variables, so it will be differentiated by the Pantelides algorithm. Afterwards, a possible maximal matching is determined, as shown in FIG. 3H.

State selection will choose either I_{L1} or I_{L2} as a state and because the rank deficiency was structurally visible, no singularities are encountered.

Use for detecting under-constrained variables and redundant equations. While the structural singularity removal is the primary purpose of this preprocessing, the original description by Otter and Elmqvist provides two additional features: (1) Detection of redundant (linear) equations and (2) Detection of under-constrained variables.

To achieve the former, first, the Bareiss process is continued for the full matrix, rather than stopping once the possible set of highest-differentiated pivots have been exhausted. If the final matrix is rank-deficient, we have redundant equations in the system. Treatment of these equations depends on the semantics of the source modeling system. An error may be raised or the redundant equation may be removed.

Dually, once the matrix is in Echelon form, under-constrained linear variable may be detected by first computing the set of variables that occur only in the integer-linear subsystem and then checking if the corresponding columns have any non-zero entries. Again, the desired semantics depend on the source modeling system. An error is recommended, but the variable may set 0.

### The DAE Transform as a Compiler Pass

Provided below is a description of the general compilation flow for obtaining a simulatable model function. The specific steps of this transformation are implemented in many existing software systems, particularly in Modelica-like systems. This provides a description of how to implement these transformations in a general-purpose compiler system.

### Structural Analysis

Structural analysis determines the variable-equation incidence matrix of a particular model component function, i.e. which variables may affect which equations. Given the above representation, this problem simply becomes taint analysis, and existing compiler infrastructure for this purpose may be re-used.

The incidence lattice element. Because of the additional information required by subsequent passes, the dataflow problem is extended slightly to also discover which variables are linear in which equations and if they are linear, what are their coefficients. In particular, the following lattice element is used:

$${inc}_{} [ {L}_{base} ] = {L}_{base} + {\vec{c}}_{inc} \cdot \vec{u}$$

Where L_{base} is some lattice element in the base lattice being extended \vec{u} is the vector of all states (both internal and external) of the current model component function and \vec{c}_{inc} is a vector of incidence coefficients with values in Rₗₙ=R∪{l, n} with l and n representing linear and nonlinear uses of the corresponding variable, respectively. The arithmetic is defined as follows:

$$a \times \{ l , n \} = \{ \begin{matrix}0 & if a = 0 \\ \{ l , n \} & if a ∈ ⋃ \{ l \} \\ n & if a = n\end{matrix}$$

$$a \pm \{ l , n \} = \{ \begin{matrix}\{ l , n \} & if a ∈ ⋃ \{ l \} \\ n & if a = n\end{matrix}$$

For illustration purposes, it is assumed that the base lattice contains at least the types {R, ⊥}∪R, i.e., that the base is a particular real value, or that is some real value, but not which one, or that the statement itself is unreachable. Depending on the underlying base lattice, additional rules may be needed. Thus, the following subtyping rules exist:

$$∀ B ∈ {base}_{} \frac{I = B + {\vec{c}}_{inc} \cdot \vec{u} B ∉}{⊥ ⊑ I ⊑ B}$$

$$∀ c ∈ , I ∈ {L}_{inc} \overline{c ⊑ I}$$

$$∀ {\vec{c}}_{inc} ∈ {ln}_{t}^{} , c ∈ \overline{( c + {\vec{c}}_{inc} \cdot \vec{u} ) ⊑ ( + {\vec{c}}_{inc} \cdot \vec{u} )}$$

A lattice element with fewer state dependencies is more specific than a lattice element with more state dependencies. As a result, constant values (with no state dependencies) are most specific. Of note, elements of the base lattice are treated as having unknown state dependence, so are treated as least specific. In particular, as lattice elements, the base lattice element R and R+0·\vec{u} are not equivalent, with the latter being significantly more specific.

A straightforward rule for type joins is as follows:

$$\frac{{I}_{a} = ( {B}_{a} + {\vec{c}}_{a} \cdot \vec{u} ) {I}_{b} = ( {B}_{b} + {\vec{c}}_{b} \cdot \vec{u} )}{{I}_{a} ⋃ {I}_{b} = {B}_{a} ⋃ {B}_{b} + \{ \begin{matrix}{( {\vec{c}}_{a} )}_{i} & if {( {\vec{c}}_{a} )}_{i} = {( {\vec{c}}_{b} )}_{i} \\ n & otherwise\end{matrix} \} \cdot \vec{u}}$$

There is, however, one subtlety concerning the intersection of constant elements from the base lattice. In the base lattice, for x∈R, y∈R, x∪y=R. This remains correct in the new lattice, but is no longer the least element. Instead, x∪y=R+\vec{0}·\vec{u}.

The inference rules for arithmetic are as expected (rules for the commutative cases, etc., are omitted).

$$\frac{a \text{::} ( {B}_{a} + {\vec{c}}_{a} \cdot \vec{u} ) b \text{::} ( {B}_{b} + {\vec{c}}_{b} \cdot \vec{u} ) ∀ x \text{::} {B}_{a} , y \text{::} {B}_{b} : ( x + y ) \text{::} {B}_{p}}{( a + b ) \text{::} ( {B}_{p} + ( {\vec{c}}_{a} + {\vec{c}}_{b} ) \cdot \vec{u} )}$$

$$\frac{a \text{::} ( {B}_{a} + {\vec{c}}_{a} \cdot \vec{u} ) b \text{::} ( x \text{::} )}{( a * b ) \text{::} ( + ( x * {\vec{c}}_{a} ) \cdot \vec{u} )}$$

$$\frac{a \text{::} ( x \text{::} + {\vec{c}}_{a} \cdot \vec{u} ) b \text{::} ( y \text{::} + {\vec{c}}_{b} \cdot \vec{u} )}{( a * b ) \text{::} ( x * y + l * ( {\vec{c}}_{a} * {\vec{c}}_{b} ) \cdot \vec{u} )}$$

$$\frac{a \text{::} ( x \text{::} + {\vec{c}}_{a} \cdot \vec{u} ) b \text{::} ( y \text{::} + {\vec{c}}_{b} \cdot \vec{u} )}{( a * b ) \text{::} ( x * y + l * ( {\vec{c}}_{a} * {\vec{c}}_{b} ) \cdot \vec{u} )}$$

$$\frac{a \text{::} ( x \text{::} + {\vec{c}}_{a} \cdot \vec{u} ) b \text{::} ( y \text{::} + {\vec{c}}_{b} \cdot \vec{u} )}{f ( a , b ) \text{::} ( + n * ( {\vec{c}}_{a} * {\vec{c}}_{b} ) \cdot \vec{u} )}$$

As is usual in taint propagation, the result of any control flow must be tainted with the taint of the condition:

$$\frac{a \text{::} {I}_{a} b \text{::} {I}_{b} c \text{::} {I}_{c}}{( a ? b : c ) \text{::} ( {I}_{a} ⋂ {I}_{b} ⋂ ( {I}_{c} ( l ) )}$$

where the *l is taken to apply the coefficient vector only, since the underlying base is some Boolean lattice element.

IPO considerations. Taint analysis is compatible with the operadic structure of the representation disclosed herein. As such, advantageously, operatic hierarchy may be used to cache the result of structural analysis without having to recompute it.

Pure operadic. In a pure operadic approach, the structural information is cached at the operad level, obtaining the matrix as shown in FIG. 3I.

Where Cᵢₒ is the incidence from the argument values to the return values, Cᵢₑ is the incidence from the argument values to the callees, Cₑₒ is the incidence from the callee's return values to the output and finally Cₑₑ block is upper triangular, since callees are dominance sorted by definition. The variable intrinsic is being treated as a callee here and allowing non-variable callees to have return values.

As applied. In the pure operadic approach, the operad was not applied and instead, the incidence was computed purely structurally. Dually, the incidence of a particular model component function can be cached in an as-applied approach, as shown in FIG. 3J.

The analysis is essentially the same, except that the only calls that introduce extra variables are calls to variable and the only calls that create entries in eᵢ are calls to equation!.

Both approaches can be used together. If C is the incidence matrix cached for an operation and Aᵢ are the incidence matrices cached for the model component functions it is being applied to, the matrix for the resulting model component function can be obtained by tensor contraction.

Operadic transform bypass. As mentioned above, the structural matrix is compatible with the operadic structure. Thus, for source modeling languages where the connection structure is manifest (for example in SPICE or the non-behavioral part of Verilog-A), the source modeling languages do not need to be lower to the representation disclosed here, but may read off the requisite incidence matrices directly from the source structure.

### Structural Singularity Removal

Structural Singularity Removal can be implemented using the method of Otter & Elmqvist described above, by extracting the integer-linear subsystem directly from the incidence matrix discovered in the previous section. However, special attention must be paid to the data structure of the coefficient matrix. In general, this matrix will be highly spare. Additionally, while the Bareiss algorithm bounds the maximal potential coefficient value, this bound is fairly large at N²/2L log(n) bits for L-bit coefficients. In practice, this bounds is not achieved except for pathological cases, but the coefficients do readily exceed 64-bits for realistic application problems. As such an implementation requires at the very least a spare matrix with big-integer coefficients.

Solving referential non-transparency. The method of Otter & Elmqvist described above was designed to handle equations arising out of the expansion of connection diagrams of the form described earlier. A particular feature of these connection diagrams is that they generally consist of plain variables with a +1 integer coefficients, for which the above system works well.

As a result, however, the method has a strong dependence on the precise lowering for the source modeling framework, which is an unsatisfying state of affairs. For example, this property is in conflict with an extended notion of referential transparency on variables. Supposing for the moment a particular embedding of electrical circuits with a resistor model is shown as):

Snippet 8

| | |
|---|---|
| 1 | function (r::Resistor)(p, n) |
| 2 | I = variable( ) |
| 3 | equation!(I − (p.V − n.V) * r.resistance) |
| 4 | p.I[ ] += I |
| 5 | n.I[ ] −= I |
| 6 | end |

With this implementation, we match the formulation described in section 7.3.1 and structural singularity removal would go through unchanged. However, the semantically equivalent is shown:

Snippet 9

| | |
|---|---|
| 1 | function (r::Resistor)(p, n) |
| 2 | I = (p.V − n.V) * r.resistance |
| 3 | p.I[ ] += I |
| 4 | n.I[ ] −= I |
| 5 | end |

The method (as described) would no longer apply because the KCL equation is no longer part of the integer-linear subsystem.

This lack of extended referential transparency, is problematic both because users unaware of this particular corner case behavior may not expect it and also, because it limits the kind of transformations that can be performed (and cached) prior to the structural singularity removal.

Here, an extension to the method of Otter & Elmqvist is performed by relying on a host compiler's global value numbering capability (equivalently running a global value renumbering optimization pass and relying on SSA statements). Supposing without loss of generality that the host compiler is SSA-based and a global value numbering pass is performed (with SSA values thus coinciding with the global value numbers), in essence, the method of Otter & Elmqvist, with the following modification is applied. Rather than taking equations as rows of our incidence matrix. The following is taken as rows: (1) The equation arguments as usual and (2) Any SSA value that is a linear combination of other SSA values and is itself used non-linearly by another row and as columns, all SSA Values that appear as terms in the linear combination.

### Automatic Differentiation

The Pantelides algorithm described above is purely structural, so there are no particular compiler considerations to its implementation. However, once computed, the result of the Pantelides algorithm does direct to differentiate certain equations, so it must be determined how to generate code for these differentiated equations. Here, a host system can be relied upon for its automatic differentiation (AD) capabilities.

Note that Automatic Differentiation can be performed after State Selection. However, in the present invention, the AD pass (or a subsequent re-inference) computes solvability information that can improve the quality of tearing and automatic differentiation is performed in between (but after the competition of to take advantage of batching) Pantelides and State Selection.

AD implementations generally fall into two major categories: Complier Transforms and Tape-Based Methods. In the former, AD is implemented as a transform in the compiler (either source-to-source or IR-to-IR), whereas the latter method generally builds data structures that get evaluated by an interpreter.

Here, the host environment is expected to have some form of compiler transform AD that is compatible with the embedding level of the DAE embedding. In general, any such AD system will likely work. However, for maximal efficiency and flexibility, it is preferred to use a Taylor-mode, interprocedurally demand-driven, rule-based AD transform.

As this particular flavor of AD system is not commonly available in host systems, each property is described in turn with key implementation details.

Taylor mode generally. Taylor mode automatic differentiation is a well-known and widely implemented variant of forward-mode automatic differentiation. Where forward mode automatic differentiation pushes forward an element of the tangent bundle TX, x+\dot{x} dx, Taylor mode automatic differentiation pushes forward a taylor series

$$x + \dot{x} dx + \frac{1}{2} \ddot{x} {dx}^{2} + … .$$

Note that in implementations, the x, \dot{x}, and \ddot{x} are generally stored explicitly, with the 1/n! coefficients treated implicitly. Like forward-mode automatic differentiation, it can be easily implemented in most host languages using operator overloading.

Taylor-mode vs nested forward more AD. Some forward-mode automatic differentiation systems support nesting of derivatives to compute higher order derivatives. For example, at second order, such a system would be pushing forward an element of the second-order tangent bundle T²X, which may be written as (a +b dx₁)+(c+d dx₁)dx₂. Note that in such a system, at second order, four values need to be carried forward, compared to three for the taylor series of the same order. This holds in general. An n-th order iterated forward mode requires O(n²) storage, while an n-th order taylor evaluation requires O(n) storage. However, the two techniques are not actually different. The taylor mode element is simply the quotient of the iterated forward mode under the constraint that all the dxᵢ are the dx from the taylor mode, with appropriate rescaling of the coefficients.

In the implementation of the compiler systems and methods described herein, Taylor-mode and iterated forward mode are not treated as two separate cases, but rather automatically make use of the taylor mode representation when an iterated forward mode element satisfies the appropriate symmetry conditions.

Interprocedural demand-driven AD. One of the primary difficulties encountered with both forward-mode and Taylor-mode AD systems is that while they are easy to implement as local operations (e.g. through operator overloading), this can quickly become a performance trap. In procedural systems, this generally manifests as the differentiation transform being applied to every operation downstream of the introduction point of the first tangent bundle. A sufficiently strong compiler can often perform enough dead-code elimination to bring the generated code back to acceptable performance, but at a cost of significant compile time. A similar occurrence happens in lazy, functional system where these kinds of patterns produce large trees of closures that need to be folded back by a compiler to achieve performance.

Both of these issues arise from treating the problem exclusively locally. Where, as here, full global information exists, this information can be used to only transform those statements that are required to be transformed and only transform them to the required order.

To do this, a demand-driven differentiation order analysis is first performed. As any demand-driven analysis would, it begins at sites that require derivatives (in this case, any explicit use of ddt as well as any equations that the Pantelides algorithm decided to differentiate) and walk backwards. In this, the previously computed incidence may be used to terminate the walk if the statement being considered does not have time dependence. In this manner, the appropriate differentiation order is assigned to each statement.

Then in a second pass, each statement is directly transformed to an appropriate n-th order taylor derivative (inserting bundle truncations as required).

User-Extensible Rule Systems. One of the primary issues that stands in the way of the practical use of AD systems is often the lack of coverage of AD rules for primitives. It is common to see new AD systems introduced that only support a handful of primitives, usually basic arithmetic, exponentials, and some other transcendentals. As a result, while such rule systems can be used for basic benchmarking, they are insufficient for robust use in practical applications.

Over the years, the Julia community has gone through dozens upon dozens of different implementations of AD systems. To minimize the capability gap between these systems, ChainRules.jl has emerged as a unified repository of hundreds of derivative rules. A centralized, AD-agnostic, package-extensible system of rules has many advantages. In principle, any AD system using it (and implementing it correctly) automatically obtains the full ruleset required of a production-ready AD system.

However, there are also significant complexity drawbacks to a centralized rule system as any mismatches between the desired semantics of the AD transform and the semantics of the rule system need to be bridged through additional compiler support.

The Taylor Rule Bootstrap. The mismatch between the ChainRules rule system and the AD system is particularly pronounced for a Taylor-mode AD system, such as the one described herein. In particular, ChainRules declares only first order rules. However, as mentioned above, in principle there is no difference between a Taylor mode evaluation and a nested-forward evaluation, other than taking advantage of the symmetry.

Thus, first-order rules can be bootstrapped into appropriate taylor rules using a compiler transform. The analysis for this bootstrap needs to establish a few properties for the first order rule:
The primal evaluation of the rule must be the exact same computation as the primal of the function.
The dual evaluation must respect certain purity and consistency constraints.

Under these conditions, it is guaranteed that (for taylor-mode input elements), the AD computation will yield taylor-mode outputs, and the n-th order taylor mode rule may be computed by iteratively taking the n−1st order rule of the dual computation.

### Scheduling

The result of state selection, as described above, is a matching describing which equations need to be solved for which variables. Equivalently, a DAG of variables (resp equations) exists describing the order into which the computation must be rearranged. In principle, this is relatively straightforward: Start with an empty list of statements, topologically sort the DAG, and then iteratively append all statements that contribute to the computation of the present variable, replacing future references to a solved variable by the result of the computation designated to be solved for it. However, in practice, there are several challenges.

Solving for the Variable in Question. The first question is how to solve a set of statements for a particular designated variable. Ideally, this capability is once again provided by the host compiler environment, so no particular mechanism by which to accomplish this task needs to be provided. The most important constraint is simply that any equation, variable pair that was represented as solvable to the state selection algorithm, must indeed be solvable by the transformation at the time of code-generation.

For completeness, a simple transformation is described herein that is general and satisfies these constraints. Any variable that has a constant linear coefficient in the incidence of a particular equation is treated as solvable. Then, to solve for the variable in question, all statements (including all control flow) between the variable and the equation in question are duplicated, replacing the original variable by 0. Subsequently, the resulting value is divided by the (known) linear coefficient of the original variable to obtain the desired, solved result. Duplication can be avoided for any computations that are not tainted by the original variable, and they can be used in-place.

The Question of the Interpretation of Side Effects. One primary design question is what to do with side-effecting input IR. Side effects (except those corresponding to equation!) have been ignored up to this point, as they are not required to faithfully implement most modeling functions, which are generally pure (although not always, for example, Verilog-A requires the semantic emission of certain warnings). Nevertheless, for robustness, it is desirable to specify what happens if a side effect is used inside a model function. There are several choices:
(1) Specify side-effects as being completely unordered and ignore them in the transformation.
(2) Specify side-effects as unordered, but respect predication.
(3) Suppress side-effects in most generated code, but extract them to continuous callbacks.

The first of these is undesirable, as side-effecting error paths can be incorrectly scheduled to top-level. The second is reasonable, but requires more care during scheduling. The third is likely most desirable, but requires a degree of control over the emission or suppression of side effects that is not found in most host environments.

State-Invariant Code Motion. One performance improvement that may be performed during scheduling is to pull out any state-invariant statements (i.e., computations that only depend on the model parameters) into a separate computational block that needs to run only once per model evaluation, instead of at every time point. In the Julia implementation, opaque closures are used for this purpose, as they have the requisite semantics to allow code motion across the residual in a general-purpose compiler pass.

### Code Generation

After scheduling, generating the various output products of the compilation pipeline may begin. As previously mentioned, which output products are required depends on the exact solver used. However, it is worth emphasizing that all transformations up until this point were agnostic to solver choice.

Slot Assignment. So far, the entire transformation process has dealt with semantic variables. However, for final code generation, the objects in questions are the states that are given to the differential equation solver. Without loss of generality, the states are subsets of the variables. If a state is desired that is algebraically related to the variables, and not a variable itself, a new variable may be introduced to the system, along with an equation that imposes the desired algebraic relation. The variables are states may be directly computed from the output of state selection (as the name implies). In particular, the states are:
Any explicitly selected state (these are differential states)
Any variable that was not assigned to an equation (these are the algebraic states), unless the system that is being generated is a DAE and the variable in question is the derivative of a selected state.

Similarly, an equation slot is assigned to any remaining equation that did not have an assigned variable.

The Model/RHS Function. All solvers require the ability to evaluate the RHS or residual function of the differential equation system. This output is straightforward. Any remaining calls to variable are replaced by array lookups at the appropriate state index. Any remaining calls to equation! are replaced by array assignments into the output array.

Jacobians. For solvers that require Jacobians, additional transformation is required. Again, any suitable host AD system may be used to compute Jacobians. For simplicity, the demand-driven taylor-mode AD system is a useable and effective choice. However, additional support is required to support batching of multiple tangents for the same primal.

Time Derivatives. Some solvers require partial derivatives of the model function with respect to the current time. These are partial derivatives, unlike the derivatives that are computed as the result of the Pantelides algorithm, which are total derivatives. These may be computed using the same system as the Jacobians, except with respect to the time argument, rather than the state arguments.

Continuous Callbacks and Singularities. As described above, side effecting statements may be lowered into continuous callbacks that trigger when an appropriate condition on the continuous state variables is met. In addition, a special side-effecting intrinsic may also be provided to declare discontinuities in the solution. These are supported by the solver to help the solver avoid numerical instability in the solution near these singularities.

Mass Matrices. ODE solvers support solving index-1 DAEs where the problem is expressed in mass matrix form M\dot{u}=ƒ(u, t). For these solvers, the mass matrix M needs to be additionally computed. This is straightforward, as the coefficients may be read off of any differentiated variables from the incidence and the coefficients of all algebraic constraints are 0.

Observables. In the systems and methods described herein, any non-selected variables, as well as any quantities explicitly declared by the user become “observables.” These quantities may be computed after the fact from the full set of ODE states. Code generation for these values is essentially identical to code generation for the residual, except using the solved variable markers and explicit calls to observed! as the output points, rather than the equation! calls.

### The Problem of Parameterization

In theory, parameterization is not a problem because it is always possible to take a fully parameterized model, apply the procedure and obtain the desired simulation result. If parameterization needs to be changed, then the procedure can be re-run end-to-end and obtain a new function to evaluation. This may work in theory, but does not work in practice. Performing the whole analysis, transformation and code-generation process has non-trivial costs and practitioners regularly desire to evaluate hundreds of thousands to millions of runs with slightly varied parameters.

The source model representation will generally have an extremely rich set of possible parameters. However, generating code under the assumption that all parameters may change arbitrarily is undesirable. For one, a change in parameterization may radically change the structure of the differential equation system. Additionally, it is preferred to take advantage of known parameter value to simplify and accelerate the generated code.

As such, a solution is required that allows the specification of the exact level of specialization desired for a particular process.

### Parameters Generally

So far, a closed dynamical system is generally taken to be represented by a single function without arguments, and an open dynamical system by a function that takes arguments equal to the number of incoming open variables. This assumption is now relaxed.

Now, the function presenting a closed dynamical system takes arbitrary arguments. These arbitrary arguments are the parameterization of the model. Similarly, the definition of open system is modified to allow the passthrough of (possibly derived) parameters in addition to the arguments for any states.

In practice, it is useful to simply allow arbitrary arguments, some of which may be states and some of which may be parameters to avoid unnecessary restrictions on the use of the system, in particular to have one formal argument be either a state or parameter depending on the calling context. However, it is of course always possible to introduce an additional dummy variable in this situation and an embedding with a more strict separation between variables and parameters may be appropriate for some host environments (e.g. statically typed languages).

Further, in practice, the entire parameterization of a closed dynamical system is passed as the first (i.e function) argument of the function representing the dynamical system. This restriction is not necessary, but it allows nicer interoperation with other systems that expect a single parameter object, as well as making parameterized closed dynamical systems be representable as 0-argument closures (other than the closure environment of course), which can be a useful didactic tool to extend the idea that 0-argument function represent closed dynamical systems. No such imposition is made on open dynamical system functions, to allow helper function not be easily written in any style. Where appropriate, parameters are lowered as the first argument of the function to preserve an overall coherent appearance of the parametrization.

A parameterized version of the Lorenz example is provided below:

Snippet 10

| | |
|---|---|
| 1 | struct Lorenz1{T} |
| 2 | ::T |
| 3 | ::T |
| 4 | ::T |
| 5 | end |
| 6 | |
| 7 | # x, dx/dt, y, z, a, u |
| 8 | function (1::Lorenz1)( ) |
| 9 | (; x, y, z) = variables( ) |
| 10 | equation!.(( |
| 11 | state_ddt(x) − (l. * u), |
| 12 | state_ddt(y) − (x * (l. − z) − y, |
| 13 | state_ddt(z) − (x * y − 1. * z) |
| 14 | )) |
| 15 | end |

### Representing the Source Parameterization

As mentioned above, the source language will generally have a rich semantics of parameterization. For example, common SPICE MOSFET models will have hundreds of individual model parameters. Additionally, SPICE supports subcircuit and global parameters, which are in turn used to compute model parameters and are often what the user expects to interact with.

Therefore, this is a need to develop a scheme that provides the user complete control with respect to the source model parameterization (including taking account of derived parameterizations), while mapping nicely to form that the complier can analyze.

This is accomplished through the use of parameter optics. A parameter optic is a data structure with the following interface.

For example, let o be a parameter optic defined that o·R1·(R)(x)=500 (ignoring the input value x) and the identity in all other cases. Clearly, with appropriate code generation, such an object could be used to override the R parameter of a hypothetical R1 device.

These optics can themselves be parameterized, so rather than overwriting a particular parameter to 500, this is made a parameter of the optic, and obtain an easy way to sweep the resistance of R1.

There are two important points here: (1) the parameterization of parameter optics is completely divorced from that of the model the parameter optics is being applied for. By specializing the compilation process on the parameterization of the optic, rather than the parameterization of the model, the exact parameters to sweep can be specified.

There need not be a 1-to-1 correspondence of the parameters of the optic and the parameterization of the model. For instance, consider the case when modeling an SRAM array consisting of 60 k transistors for which the width/length of each transistor is swept. Natively, this would required a parameterization with 120 k parameters. However, using the optic approach, a single optic can be written that applies to all transistors and is itself parameterized by only two values.

Optics are hierarchy preserving. For optics like in the SRAM example, every transistor will have applied to it an identical optic, so it is readily apparent to the compiler that all transistors have equivalent length/width, and the results of this computation may be cached and shared among all instances of the model.

### Automatic Splitting Set Synthesis

Depending on how the semantic richness of the source parametrization, it is generally possible for the parameterization to affect the structure of the differential equation system (either by explicitly adding additional equations to the model, or implicitly, e.g., by shorting out a component). In general, a structural change in the differential equation system requires a redo of the analysis and code generation. Of course, a similar situation can happen at runtime, requiring dynamic state selection. This is trickier, because it in general requires support in the differential equation solver to monitor the non-singularity of the Jacobian. However, where the structure is state-independent (i.e., dependent only on the parameterization), we can automatically synthesize the appropriate code to validate that the parameterization meets the assumptions of the previous structural analysis. A general weakest-precondition synthesis pass is well-suited to this requirement.

### Implementing SPICE

### Operadic Embedding

As discussed previously, SPICE represents a parameterized UWD algebra, so the recipe for embedding parameterized UWD algebras into code can be followed. In the SPICE UWD-algebra, the spider represents electrical nets. Compiler intrinsics is usable for this. However (at least for an embedding into Julia), it turns out that this is unnecessary (as long as a semantic transformation on the representation is not needed), as the intrinsic is implementable using standard Julia semantics and the embedding as previously defined for dynamical systems. In particular, the spider of this UWD algebra is defined as:

Snippet 11

| | |
|---|---|
| 1 | mutable struct Net |
| 2 | const V::Float 64 |
| 3 | I::Float64 |
| 4 | function Net( ) |
| 5 | this = new(variable( ), 0.) |
| 6 | finalizer(kcl!, this) |
| 7 | return this |
| 8 | end |
| 9 | end |
| 10 | kcl!(n::Net) = equation!(n.I) |

An example resistor implementation looks like:

Snippet 12

| | |
|---|---|
| 1 | struct Resistor |
| 2 | R::Float64 |
| 3 | end |
| 4 | |
| 5 | function (r::Resistor)(p::Net, n::Net) |
| 6 | I = (p.V−n.V)/r.R |
| 7 | p.I += I |
| 8 | n.I −= I |
| 9 | end |

This will work correctly so long as the finalizer is semantically guaranteed to execute before the end of the top-level model function. The Julia host language currently does not make sure guarantees, but it does opportunistically inline finalizers where possible. Under suitable conditions on the generated code and with sufficient inlining, it is possible to rely on this mechanism to inert the equation! Call in the appropriate place.

However, this is unsatisfying as the aforementioned inlining requirement makes it hard to perform structure-aware caching of the embedding. As briefly discussed above, switch to a split representation of equations, where equations are operadically composed, and their side effects contribute additively to the equation in question. With this embedding, an example is provided:

Snippet 13

| | |
|---|---|
| 1 | mutable struct Net |
| 2 | const V::Float64 |
| 3 | kcl!( |
| 4 | function Net( ) |
| 5 | this = new(variable( ), 0.) |
| 6 | finalizer(kcl!, this) |
| 7 | return this |
| 8 | end |
| 9 | end |

With the resistor example looking as follows:

Snippet 14

| | |
|---|---|
| 1 | struct Resistor |
| 2 | R::Float 64 |
| 3 | end |
| 4 | |
| 5 | function (r::Resistor)(p::Net, n::Net) |
| 6 | I = (p.V − n.V)/r.R |
| 7 | p.kcl!(I) |
| 8 | n.kcl!(−I) |
| 9 | end |

Which of these embeddings works better will depend on the characteristics of the host language. For example, for a language with strong lifetime guarantees and the accompanying compiler analysis support, the first embedding may be entirely fine. For a chosen host compiler, the second embedding performed better.

Referring to FIG. 3A, the DAE compiler 300 may receive a SPICE model 302, a Verilog-A model 304, or a Modelica model 306. Those models are parsed into abstract syntax trees 308, 310, and/or 312, respectively. The abstract syntax tree(s) are used to generate a general-purpose intermediate representation (IR) and intrinsics 314. From the general-purpose IR, general-purpose optimization is performed to generate intermediate representation 316. From the intermediate representation, structural analysis, as described in detail above, is performed to generate structure 318. Index reduction, as described in detail above, is performed to generate structure 320. The structural analysis and index reduction can be used to generate automatic differentiation requirements, as described in detail above. General-purpose automatic differentiation is performed on the intermediate representation 316 to generate intermediate representation 322. Structural analysis is performed on the intermediate representation. State selection, as described in detail above, is performed to generate structure 324. The selected states from state selection are used to schedule the intermediate representation. At this point, DAE/ODE lowering is performed on the intermediate representation 326. General-purpose automatic differentiation is performed, which generates intermediate representation 328. From intermediate representation 328, callback generation is performed to generate a callback executable 330. Intermediate representation 336 is used to generate Jacobians (J executable) 340. Intermediate representation 326 is used to generate intermediate representation 332 and mass matrices (MM executable) 334. Intermediate representation 332 is used to generate residuals (RHS executable) 338. Residuals 338, mass matrices 334, Jacobians 340, and callback executable 330 are provided as inputs to flexible solver 342, which is then able to solve the model using these inputs, thereby solving the DAE transform problem, as described herein.

### Implementing Verilog-A (and Similar)

Verilog-A (and similar languages like VHDL-AMS) combine structural aspects with direct equation-based modeling. The structural composition of circuits may be implemented as described for SPICE above. The implementation of the Verilog-A equation-based primitives may be the trivial implementation that directly lowers to the appropriate “variable”/“equation” calls. If the host language does not expose demand-driven AD capabilities, the Verilog-A “ddt” and “ddx” intrinsics may be implemented using traditional forward-mode automatic differentiation, although demand-driven AD is preferred for performance.

### Implementing Modelica

The process for implementing the Modelica language is similar to that of Verilog-A, as it, too, combines equation-based and structural modeling aspects. However, the Modelica language presents additional complications, as the Modelica connection graph, requires a non-trivial expansion algorithm to resolve over-constrained connectors and other complications. In the system described herein, this can be implemented as additional intrinsics of the intermediate representation.

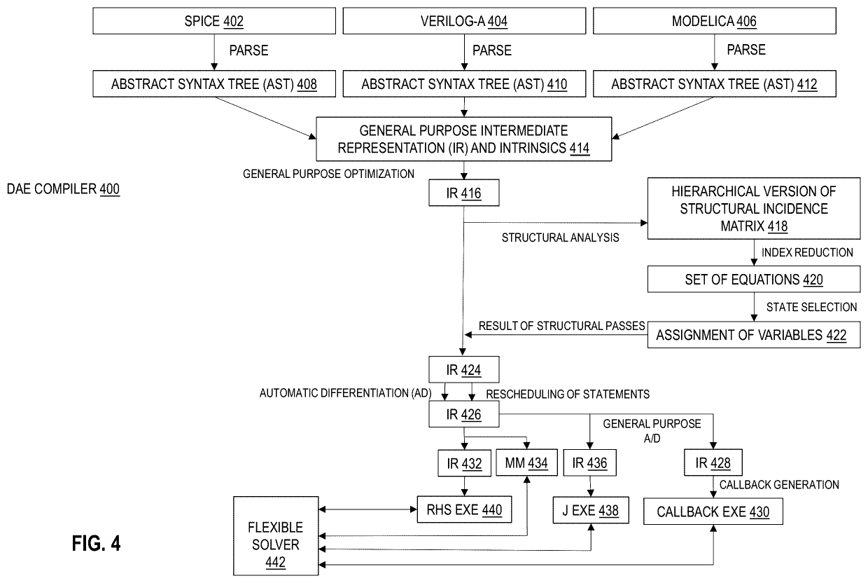

FIG. 4 depicts an exemplary process flow of a compiler system for differential algebraic equations simulations according to one embodiment of the present invention. Referring to FIG. 4, the process and data flow of FIG. 4 is similar to that of FIG. 3A; however, there are some differences, as shown in FIG. 4. The DAE compiler 400 may receive a SPICE model 402, a Verilog-A model 404, or a Modelica model 406. Those models are parsed into abstract syntax trees 408, 410, and/or 412, respectively. The abstract syntax tree(s) are used to generate a general-purpose intermediate representation (IR) and intrinsics 414. From the general-purpose IR, general-purpose optimization is performed to generate intermediate representation 416. From the intermediate representation, structural analysis, as described in detail above, is performed to generate a hierarchical version of the structural incidence matrix 418. From there, index reduction, as described in detail above, is performed to generate a set of equations 420. From the set of equations, state selection, as described in detail above, is performed to generate an assignment of variables 422. The result of the structural passes is used to generate intermediate representation 424. Automatic differentiation is performed, and a rescheduling of statements is performed to generate intermediate representation 426. From intermediate representation 426, intermediate representation 432 and mass matrices 434 are generated. Residuals (RHS executable) 440 is generated from intermediate representation 432. Intermediate representation 436 is generated and used to generate Jacobians (J executable) 438. General-purpose automatic differentiation is performed on intermediate representation 426 to generate intermediate representation 428. Callback generation is performed on intermediate representation 428, which generates callback executable 430. Residuals 440, mass matrices 434, Jacobians 438, and callback executable 430 are provided as inputs to flexible solver 442, which is then able to solve the model using these inputs, thereby solving the DAE transform problem, as described herein.

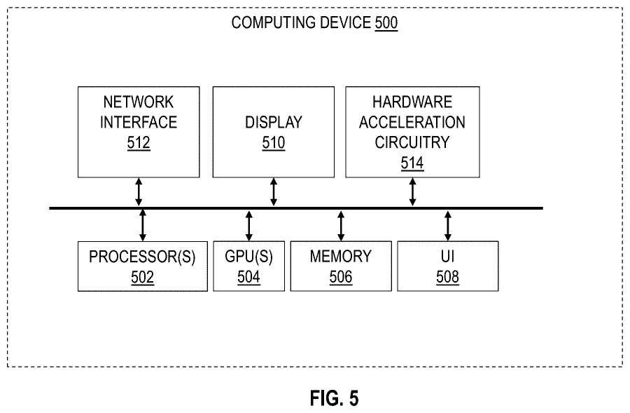

FIG. 5 depicts a block diagram illustrating one embodiment of a computing device that implements the methods and systems described herein. Referring to FIG. 5, the computing device 500 may include at least one processor 502, at least one graphical processing unit (“GPU”) 504, a memory 506, a user interface (“UI”) 508, a display 510, a network interface 512, and hardware acceleration circuitry 514. The memory 506 may be partially integrated with the processor(s) 502, the GPU(s) 504, and/or the hardware acceleration circuitry 514. The hardware acceleration circuitry 514 may be specialized circuitry or hardware specific circuitry, such as an ASIC or FPGA. The UI 508 may include a keyboard and a mouse. The display 510 and the UI 508 may provide any of the GUIs in the embodiments of this disclosure.

The methods described herein may be implemented on one or more computing devices, such as the computing device described in the context of FIG. 5.

In one embodiment described herein, compiler system for generating an intermediate representation of a program that represents a DAE system for a source modeling language is disclosed. The compiler system includes one or more hardware processors. The one or more hardware processors are configured for receiving two compiler inputs. A first compiler input is a model of a physical system from one or more of a plurality of source modeling languages. The model is a textual or graphical representation of the physical system. A second compiler input is a first intermediate representation for each subroutine specific to the model of the physical system. The one or more hardware processors are further configured for compiling the model to a second intermediate representation that is universal across each of the plurality of source modeling languages. The intermediate representation maps each primitive of each source modeling language to a subroutine call specific to the source modeling language from which the primitive is derived. The one or more hardware processors are further configured for combining the first intermediate representation and the second intermediate representation into a third intermediate representation that describes the model in terms of intrinsics of the third intermediate representation.

In one embodiment of the compiler system the first intermediate representation, the second intermediate representation, and the third intermediate representation are each a representation of a source general-purpose programming language.

In one embodiment of the compiler system, the first intermediate representation, the second intermediate representation, and the third intermediate representation are each a general-purpose compiler intermediate representation.

In one embodiment of the compiler system, the intrinsics of the third intermediate representation include an intrinsic that defines a variable and an intrinsic that defines a residual of an equation.

In one embodiment of the compiler system, the intrinsics include an intrinsic that exposes automatic differentiation capabilities.

In one embodiment of the compiler system, the lowering to the intermediate representation is performed such that a level of parameter specialization is explicitly user-controlled. The user-controlled parameter specialization may be a parameter optic.

In one embodiment of the compiler system, the hierarchical structure of the source modeling language is preserved as subroutine calls in the first intermediate representation, the second intermediate representation, and the third intermediate representation.

In one embodiment of the compiler system, the source modeling language is SPICE, Verilog-A, Modelica, or VHDL-AMS.

In another embodiment described herein, a compiler system for implementation on a general-purpose compiler for a source modeling language is disclosed. The compiler system includes one or more hardware processors. The one or more hardware processors are configured for receiving an intermediate representation of a program that represents a differential algebraic equations (DAE) system in the source modeling language. The one or more hardware processors are further configured for performing structural analysis at the intermediate representation level to generate a hierarchical version of a structural incidence matrix about the DAE system. The one or more hardware processors are further configured for performing the following computing pipeline operations one or more times. In a first computing pipeline operation, the one or more hardware processors are configured for running a plurality of structural passes using the hierarchical version of the structural incidence matrix of the DAE system. A first structural pass performs index reduction to generate a set of equations to differentiate. A second structural pass performs state selection to generate an assignment of variables for the set of equations to differentiate, with each variable being represented as assigned to a particular equation, unassigned, or a selected state. The generated set of equations to differentiate and the generated assignment of variables together form a result of the structural passes. In a second computing pipeline operation, the one or more hardware processors are configured for transforming the intermediate representation based on the result of the structural passes. Transforming the intermediate representation includes performing automatic differentiation on the intermediate representation; and rescheduling statements of the intermediate representation. The first computing pipeline and the second computing pipeline operations are run in parallel. The one or more hardware processors are further configured for transforming each of a plurality of copies of the intermediate representation to be used with a numerical solver. The one or more hardware processors are further configured for compiling each of the plurality of copies into an executable or other data structure for input to a numerical solver. The one or more hardware processors are further configured for providing each of the executables or other data structures to the numerical solver.

In one embodiment of the compiler system, the compiler system uses hierarchy information in the intermediate representation to reduce compilation time and to reduce size of the generated code by avoiding unnecessary repetition of computations. The hierarchical information may be leveraged by reusing the inter-procedural analysis and optimization infrastructure of the general-purpose compiler.

In one embodiment of the compiler system, the one or more hardware processors is further configured for removing structural singularity from the received DAE system.

In one embodiment of the compiler system, the one or more hardware processors is further configured for performing a global value numbering analysis to enhance the information available to the structural singularity removal.

In one embodiment of the compiler system, the one or more hardware processors use existing infrastructure of the general-purpose compiler.

In one embodiment of the compiler system, the structural analysis is performed using existing infrastructure of the general-purpose compiler.

In one embodiment of the compiler system, the transformations are performed using existing infrastructure of the general-purpose compiler.

In one embodiment of the compiler system, the automatic differentiation is performed using a general-purpose automatic differentiation system.

In one embodiment of the compiler system, the automatic differentiation is performed using inter-procedural, demand-driven Taylor-mode automatic differentiation.

In one embodiment of the compiler system, the plurality of outputs include one or more of the following: residuals, jacobians, mass matrices, time derivatives, continuous and discrete callbacks, and discontinuity information.

In one embodiment of the compiler system, the computing pipeline operations are performed two times, with the first of the two times being performed for DAE initialization and the second of the two times being performed for simulation.

In another embodiment described herein, a simulator for simulating a physical system is disclosed. The simulator includes a first compiler system as described above, a second compiler system as described above, and a general-purpose numerical solver. The output of the first compiler system and the output of the second compiler system are provided to the general-purpose numerical solver to generate simulation results.

In an embodiment of the simulator described herein, the physical system is electrical circuits, and the input modeling language is at least one of SPICE and Verilog-A.

In an embodiment of the simulator described herein, the simulation results include one or more of the following: transient analysis, DC operating point analysis, AC large and small signal analysis, harmonic balance analysis, transient noise analysis, and sensitivity analysis.

In an embodiment of the simulator described herein, derivatives of the simulation results with respect to arbitrary parameters can be obtained.

In an embodiment of the simulator described herein, the input to the first compiler is Modelica or VHDL-AMS.

In one embodiment described herein, a programmatic method for generating an intermediate representation of a program that represents a DAE system for a source modeling language is disclosed. The programmatic method includes receiving two compiler inputs. A first compiler input is a model of a physical system from one or more of a plurality of source modeling languages. The model is a textual or graphical representation of the physical system. A second compiler input is a first intermediate representation for each subroutine specific to the model of the physical system. The programmatic method further includes compiling the model to a second intermediate representation that is universal across each of the plurality of source modeling languages. The intermediate representation maps each primitive of each source modeling language to a subroutine call specific to the source modeling language from which the primitive is derived. The programmatic method further includes combining the first intermediate representation and the second intermediate representation into a third intermediate representation that describes the model in terms of intrinsics of the third intermediate representation.

In an embodiment of the programmatic method described herein, the first intermediate representation, the second intermediate representation, and the third intermediate representation are each a representation of a source general-purpose programming language.

In an embodiment of the programmatic method described herein, the first intermediate representation, the second intermediate representation, and the third intermediate representation are each a general-purpose compiler intermediate representation.

In an embodiment of the programmatic method described herein, the intrinsics of the third intermediate representation include an intrinsic that defines a variable and an intrinsic that defines a residual of an equation.

In an embodiment of the programmatic method described herein, the intrinsics include an intrinsic that exposes automatic differentiation capabilities.

In an embodiment of the programmatic method described herein, the lowering to the intermediate representation is performed such that a level of parameter specialization is explicitly user-controlled. The user-controlled parameter specialization may be a parameter optic.

In an embodiment of the programmatic method described herein, the hierarchical structure of the source modeling language is preserved as subroutine calls in the first intermediate representation, the second intermediate representation, and the third intermediate representation.

In an embodiment of the programmatic method described herein, the source modeling language is SPICE, Verilog-A, Modelica, or VHDL-AMS.

In another embodiment described herein, a programmatic method for implementation on a general-purpose compiler for a source modeling language is disclosed. The programmatic method includes receiving an intermediate representation of a program that represents a differential algebraic equations (DAE) system in the source modeling language. The programmatic method further includes performing structural analysis at the intermediate representation level to generate a hierarchical version of a structural incidence matrix about the DAE system. The programmatic method further includes performing the following computing pipeline operations one or more times. In a first computing pipeline operation, the programmatic method includes running a plurality of structural passes using the hierarchical version of the structural incidence matrix of the DAE system. A first structural pass performs index reduction to generate a set of equations to differentiate. A second structural pass performs state selection to generate an assignment of variables for the set of equations to differentiate, with each variable being represented as assigned to a particular equation, unassigned, or a selected state. The generated set of equations to differentiate and the generated assignment of variables together form a result of the structural passes. In a second computing pipeline operation, the programmatic method includes transforming the intermediate representation based on the result of the structural passes, wherein transforming the intermediate representation includes. Transforming the intermediate representation includes performing automatic differentiation on the intermediate representation and rescheduling statements of the intermediate representation. The first computing pipeline and the second computing pipeline are run in parallel. The programmatic method further includes transforming each of a plurality of copies of the intermediate representation to be used with a numerical solver. The programmatic method further includes compiling each of the plurality of copies into an executable or other data structure for input to a numerical solver. The programmatic method further includes providing each of the executables or other data structures to the numerical solver.

In an embodiment of the programmatic method described herein, the compiler system uses hierarchy information in the intermediate representation to reduce compilation time and to reduce size of the generated code by avoiding unnecessary repetition of computations. The hierarchical information may be leveraged by reusing the inter-procedural analysis and optimization infrastructure of the general-purpose compiler.

In an embodiment of the programmatic method described herein, the programmatic method further includes removing structural singularity from the received DAE system.

In an embodiment of the programmatic method described herein, the programmatic method further includes performing a global value numbering analysis to enhance the information available to the structural singularity removal.

In an embodiment of the programmatic method described herein, the programmatic method uses existing infrastructure of the general-purpose compiler.

In an embodiment of the programmatic method described herein, the structural analysis is performed using existing infrastructure of the general-purpose compiler.

In an embodiment of the programmatic method described herein, the transformations are performed using existing infrastructure of the general-purpose compiler.

In an embodiment of the programmatic method described herein, the automatic differentiation is performed using a general-purpose automatic differentiation system.

In an embodiment of the programmatic method described herein, the automatic differentiation is performed using inter-procedural, demand-driven Taylor-mode automatic differentiation.

In an embodiment of the programmatic method described herein, the plurality of outputs include one or more of the following: residuals, jacobians, mass matrices, time derivatives, continuous and discrete callbacks, and discontinuity information.

In an embodiment of the programmatic method described herein, the computing pipeline operations are performed two times, with the first of the two times being performed for DAE initialization and the second of the two times being performed for simulation.

In an embodiment of the programmatic method described herein, the plurality of outputs include one or more of the following: residuals, jacobians, mass matrices, time derivatives, continuous and discrete callbacks, and discontinuity information.

In an embodiment of the programmatic method described herein, the computing pipeline operations are performed two times, with the first of the two times being performed for DAE initialization and the second of the two times being performed for simulation.

In another embodiment described herein, a programmatic method for simulating a physical system is disclosed. The programmatic method includes a first programmatic method for generating an intermediate representation of a program that represents a DAE system for a source modeling language as described herein. The programmatic method further includes a second programmatic method for implementation on a general-purpose compiler for a source modeling language as described herein. The programmatic method further includes providing the output of the first programmatic method and the output of the second programmatic method to a general-purpose numerical solver to generate simulation results.

In an embodiment of the programmatic method described herein, the physical system is electrical circuits, and the input modeling language is at least one of SPICE and Verilog-A.

In an embodiment of the programmatic method described herein, the simulation results include one or more of the following: transient analysis, DC operating point analysis, AC large and small signal analysis, harmonic balance analysis, transient noise analysis, and sensitivity analysis.

In an embodiment of the programmatic method described herein, derivatives of the simulation results with respect to arbitrary parameters can be obtained.

In an embodiment of the programmatic method described herein, the input to the first compiler is Modelica or VHDL-AMS.

Aspects of the present disclosure may take the form of an entirely hardware embodiment, an entirely software embodiment as a programmatic method (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including the Julia scientific computing language or an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These non-transitory computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

These and other changes can be made to the disclosure in light of the Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

The subject matter described herein may include the use of machine learning performed by at least one processor of a computing device and stored as non-transitory computer executable instructions (software or source code) embodied on a non-transitory computer-readable medium (memory). Machine learning (ML) is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The systems and methods may support different hardware platforms/architectures, may add implementations for new network layers and new hardware platforms/architectures, and may be optimized in terms of processing, memory and/or other hardware resources for a specific hardware platform/architecture being targeted. Examples of platforms are different GPUs (e.g., Nvidia GPUs, ARM Mali GPUs, AMD GPUs, etc.), different forms of CPUs (e.g., Intel Xeon, ARM, TI, etc.), and programmable logic devices, such as Field Programmable Gate Arrays (FPGAs).

Exemplary target platforms include host computers having one or more single core and/or multicore CPUs and one or more Parallel Processing Units (PPUs), such as Graphics Processing Units (GPUs), and embedded systems including single and/or multicore CPUs, microprocessors, Digital Signal Processors (DSPs), and/or Field Programmable Gate Arrays (FPGAs).

The subject matter described herein may be executed using a distributed computing environment. The environment may include client and server devices, interconnected by one or more networks. The distributed computing environment also may include target platforms. The target platform may include a multicore processor. Target platforms may include a host (Central Processing Unit) and a device (Graphics Processing Unit). The servers may include applications or processes accessible by the clients. The devices of the environment may interconnect via wired connections, wireless connections, or a combination of wired and wireless connections.

The servers may include one or more devices capable of receiving, generating, storing, processing, executing, and/or providing information. For example, servers may include a computing device, such as a server, a desktop computer, a laptop computer, a tablet computer, a handheld computer, or a similar device.

The clients may be capable of receiving, generating, storing, processing, executing, and/or providing information. Information may include any type of machine-readable information having substantially any format that may be adapted for use, e.g., in one or more networks and/or with one or more devices. The information may include digital information and/or analog information. The information may further be packetized and/or non-packetized. In an embodiment, the clients may download data and/or code from the servers via the network. In some implementations, the clients may be desktop computers, workstations, laptop computers, tablet computers, handheld computers, mobile phones (e.g., smart phones, radiotelephones, etc.), electronic readers, or similar devices. In some implementations, the clients may receive information from and/or transmit information to the servers.

The subject matter described herein and/or one or more of its parts or components may comprise registers and combinational logic configured and arranged to produce sequential logic circuits. In some embodiments, the subject matter described herein may be implemented through one or more software modules or libraries containing program instructions pertaining to the methods described herein, that may be stored in memory and/or on computer readable media, and may be executed by one or more processors. Other computer readable media may also be used to store and execute these program instructions. In alternative embodiments, various combinations of software and hardware, including firmware, may be utilized to implement the present disclosure.

The descriptions of the various embodiments of the technology disclosed herein have been presented for purposes of illustration, but these descriptions are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A compiler system for generating an intermediate representation of a program that represents a DAE system for a source modeling language, the compiler system comprising:
one or more hardware processors configured for:
receiving two compiler inputs,
wherein a first compiler input is a model of a physical system from one or more of a plurality of source modeling languages, wherein the model is a textual or graphical representation of the physical system,
wherein a second compiler input is a first intermediate representation for each subroutine specific to the model of the physical system;
compiling the model to a second intermediate representation that is universal across each of the plurality of source modeling languages,
wherein the intermediate representation maps each primitive of each source modeling language to a subroutine call specific to the source modeling language from which the primitive is derived,
combining the first intermediate representation and the second intermediate representation into a third intermediate representation that describes the model in terms of intrinsics of the third intermediate representation.

2. The compiler system of claim 1, wherein the first intermediate representation, the second intermediate representation, and the third intermediate representation are each a representation of a source general-purpose programming language.

3. The compiler system of claim 1, wherein the first intermediate representation, the second intermediate representation, and the third intermediate representation are each a general-purpose compiler intermediate representation.

4. The compiler system of claim 1, wherein the intrinsics of the third intermediate representation include an intrinsic that defines a variable and an intrinsic that defines a residual of an equation.

5. The compiler system of claim 1, wherein the intrinsics include an intrinsic that exposes automatic differentiation capabilities.

6. The compiler system of claim 1, wherein the lowering to the intermediate representation is performed such that a level of parameter specialization is explicitly user-controlled.

7. The compiler system of claim 1, wherein the hierarchical structure of the source modeling language is preserved as subroutine calls in the first intermediate representation, the second intermediate representation, and the third intermediate representation.

8. The compiler system of claim 1, wherein the source modeling language is SPICE, Verilog-A, Modelica, or VHDL-AMS.

9. A compiler system for implementation on a general-purpose compiler for a source modeling language, the compiler system comprising:
one or more hardware processors configured for:
receiving an intermediate representation of a program that represents a differential algebraic equations (DAE) system in the source modeling language;
performing structural analysis at the intermediate representation level to generate a hierarchical version of a structural incidence matrix about the DAE system;
performing the following computing pipeline operations one or more times:
in a first computing pipeline operation, running a plurality of structural passes using the hierarchical version of the structural incidence matrix of the DAE system,
wherein a first structural pass performs index reduction to generate a set of equations to differentiate,
wherein a second structural pass performs state selection to generate an assignment of variables for the set of equations to differentiate, with each variable being represented as assigned to a particular equation, unassigned, or a selected state,
wherein the generated set of equations to differentiate and the generated assignment of variables together form a result of the structural passes;
in a second computing pipeline operation, transforming the intermediate representation based on the result of the structural passes, wherein transforming the intermediate representation includes:
performing automatic differentiation on the intermediate representation; and
rescheduling statements of the intermediate representation;
wherein the first computing pipeline operation and the second computing pipeline operation are run in parallel;
transforming each of a plurality of copies of the intermediate representation to be used with a numerical solver;
compiling each of the plurality of copies into an executable or other data structure for input to a numerical solver; and
providing each of the executables or other data structures to the numerical solver.

10. The compiler system of claim 9, wherein the compiler system uses hierarchy information in the intermediate representation to reduce compilation time and to reduce size of the generated code by avoiding unnecessary repetition of computations.

11. The compiler system of claim 9, wherein the one or more hardware processors is further configured for removing structural singularity from the received DAE system.

12. The compiler system of claim 9, wherein the one or more hardware processors use existing infrastructure of the general-purpose compiler.

13. The compiler system of claim 9, wherein at least one of the structural analysis or the transformations is performed using existing infrastructure of the general-purpose compiler.

14. The compiler system of claim 9, where the automatic differentiation is performed using a general-purpose automatic differentiation system.

15. The compiler system of claim 9, wherein the automatic differentiation is performed using inter-procedural, demand-driven Taylor-mode automatic differentiation.

16. The compiler system of claim 9, wherein the plurality of outputs include one or more of the following: residuals, jacobians, mass matrices, time derivatives, continuous and discrete callbacks, and discontinuity information.

17. The compiler system of claim 9, wherein the computing pipeline operations are performed two times, with the first of the two times being performed for DAE initialization and the second of the two times being performed for simulation.

18. A programmatic method for implementation on a general-purpose compiler for a source modeling language, the programmatic method comprising:
receiving an intermediate representation of a program that represents a differential algebraic equations (DAE) system in the source modeling language;
performing structural analysis at the intermediate representation level to generate a hierarchical version of a structural incidence matrix about the DAE system;
perform the following computing pipeline operations one or more times:
in a first computing pipeline operation, running a plurality of structural passes using the hierarchical version of the structural incidence matrix of the DAE system,
wherein a first structural pass performs index reduction to generate a set of equations to differentiate,
wherein a second structural pass performs state selection to generate an assignment of variables for the set of equations to differentiate, with each variable being represented as assigned to a particular equation, unassigned, or a selected state,
wherein the generated set of equations to differentiate and the generated assignment of variables together form a result of the structural passes;
in a second computing pipeline operation, transforming the intermediate representation based on the result of the structural passes, wherein transforming the intermediate representation includes:
performing automatic differentiation on the intermediate representation; and
rescheduling statements of the intermediate representation;
wherein the first computing pipeline operation and the second computing pipeline operation are run in parallel;
transforming each of a plurality of copies of the intermediate representation to be used with a numerical solver;
compiling each of the plurality of copies into an executable or other data structure for input to a numerical solver; and
providing each of the executables or other data structures to the numerical solver.

19. The programmatic method of claim 18, wherein the programmatic method uses hierarchy information in the intermediate representation to reduce compilation time and to reduce size of the generated code by avoiding unnecessary repetition of computations.

20. The programmatic method of claim 18, further comprising removing structural singularity from the received DAE system.

21. The programmatic method of claim 18, wherein at least one of the structural analysis or the transformations is performed using existing infrastructure of the general-purpose compiler.

22. The programmatic method of claim 18, where the automatic differentiation is performed using a general-purpose automatic differentiation system.

23. The programmatic method of claim 18, wherein the plurality of outputs include one or more of the following: residuals, jacobians, mass matrices, time derivatives, continuous and discrete callbacks, and discontinuity information.

24. The programmatic method of claim 18, wherein the computing pipeline operations are performed two times, with the first of the two times being performed for DAE initialization and the second of the two times being performed for simulation.
